(19) United States
(12) Patent Application Publication
(10) Pub. No.: US 2021/0284192 A1
(43) Pub. Date: Sep. 16, 2021

(54) MOVABLE OBJECT CONTROL DEVICE, MOVABLE OBJECT CONTROL METHOD, AND STORAGE MEDIUM STORING PROGRAM

(71) Applicant: HONDA MOTOR CO., LTD., Tokyo (JP)

(72) Inventor: Koichi OGURA, Wako-shi (JP)

(21) Appl. No.: 17/193,987

(22) Filed: Mar. 5, 2021

(30) Foreign Application Priority Data
Mar. 10, 2020 (JP) 2020-040683

(51) Int. Cl. B60W 60/00; B60Q 1/50; G06K 9/00

(52) U.S. Cl. CPC B60W 60/001; B60Q 1/50; B60W 2552/53; B60W 2552/05; G06K 9/00798

(57) ABSTRACT

A movable object control device includes: an image recognition part configured to recognize a road classification made to correspond to a travel condition which includes whether or not an autonomous travel of the movable object is available on a road on which the movable object travels, or an autonomous travel level thereon, or both, based on information obtained from an image taken by an imaging device of the movable object; and a control part configured to, when the image recognition part has recognized a prescribed shape or a prescribed image pattern made to correspond to the road classification, on or around the road on which the movable object travels, perform an autonomous travel of the movable object, based on the travel condition corresponding to the road classification.

### CROSS REFERENCE TO RELATED APPLICATIONS

This application claims the benefit of Japanese Patent Application No. 2020-040683 filed on Mar. 10, 2020, the disclosure of which is incorporated herein by reference.

### BACKGROUND OF THE INVENTION

### 1. Field of the Invention

The present invention relates to a movable object control device, a movable object control method, and a storage medium storing program.

### 2. Description of the Related Art

A technology called automated driving has been proposed to achieve a safe and comfortable travel when a driver runs a vehicle, while reducing burden on the driver. For example, Japanese Laid-Open Patent Application, Publication No. 2020-1668 (which may also be referred to as Patent Document 1 hereinafter) describes the automated driving, disclosing “recognizing a travel lane on a road on which a subject vehicle is traveling, on the basis of an image obtained by imaging an area in front of the subject vehicle”.

### RELATED ART DOCUMENT

### Patent Document

[Patent Document 1] Japanese Laid-Open Patent Application, Publication No. 2020-1668

### SUMMARY OF THE INVENTION

Patent Document 1 fails to disclose, however, that, when a road marking or a road signage regarding automated driving of vehicles is provided on a surface of a road of interest or at or near the road, how the road marking or the road signage is reflected to an automated driving of a vehicle actually traveling on the road, so as to give a sense of safety to nearby traffic participants walking or the like on or around the road.

In light of the described above, the present invention has been made in an attempt to provide a movable object control device, a movable object control method, and a storage medium storing program, each of which can provide a traffic participant with a sense of safety.

A movable object control device includes: an image recognition part configured to recognize a road classification made to correspond to a travel condition which includes whether or not an autonomous travel of the movable object is available on a road on which the movable object travels, or an autonomous travel level thereon, or both, based on information obtained from an image taken by an imaging device of the movable object; and a control part configured to, when the image recognition part has recognized a prescribed shape or a prescribed image pattern made to correspond to the road classification, on or around the road on which the movable object travels, perform an autonomous travel of the movable object, based on the travel condition corresponding to the road classification.

The present invention can provide a movable object control device, a movable object control method, and a storage medium storing program, each of which can provide a traffic participant with a sense of safety.

### BRIEF DESCRIPTION OF THE DRAWINGS

FIG. 1 is a diagram for explaining a state of an area surrounding a vehicle that includes a control device according to a first embodiment of the present invention.

FIG. 2 is a diagram for explaining a driving assistance system that includes the vehicle including the control device according to the first embodiment.

FIG. 3 is a functional block diagram illustrating the control device according to the first embodiment.

FIG. 4 is a flowchart of a processing performed by the control device according to the first embodiment.

FIG. 5 is a functional block diagram including a control device according to a second embodiment of the present invention.

FIG. 6 is a diagram for explaining a data table included in geographical information in the control device according to the second embodiment.

FIG. 7 is a flowchart of a processing performed by the control device according to the second embodiment.

FIG. 8 is a flowchart of a processing performed by a control device according to a third embodiment of the present invention.

FIG. 9A is a diagram for explaining an example of a display in a panel display of a vehicle including the control device, when an autonomous travel is performed in accordance with a road classification, according to the third embodiment.

FIG. 9B is a diagram for explaining an example of a display in a panel display of the vehicle including the control device, when an autonomous travel is performed at a level different from that in accordance with a road classification, according to the third embodiment.

### DETAILED DESCRIPTION OF THE EMBODIMENTS

### First Embodiment

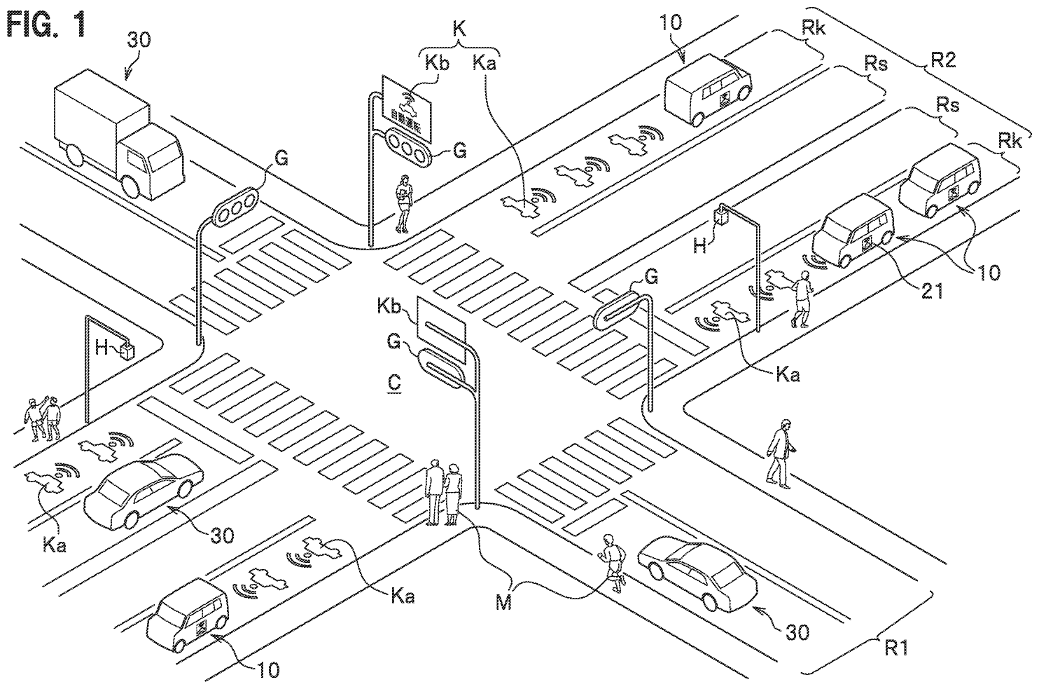

FIG. 1 is a diagram for explaining a state of an area surrounding a vehicle 10 that includes a control device according to a first embodiment of the present invention.

FIG. 1 illustrates, as an example, an area surrounding an intersection C of a two-lane road R1 and a four-lane road R2. Reference numeral 10 indicates a vehicle which performs an autonomous travel; and, reference numeral 30, a vehicle which does not perform an autonomous travel. In this embodiment, description is made focusing on the vehicle 10 which performs an autonomous travel.

As illustrated in FIG. 1, there are a traffic light G, a roadside device H, a road marking Ka provided on a road surface, a road signage Kb installed at or near a road, and the like, in the area at and surrounding the intersection C. The road marking Ka and the road signage Kb are herein collectively referred to as a traffic sign K. The traffic sign K represents a prescribed “road classification” concerning an autonomous travel (a so-called an automated driving) of the vehicle 10 (which may also be referred to as a movable object). The “road classification” is associated with a travel condition of a road on which the vehicle 10 travels (such as whether or not an autonomous travel is available thereon and a level of the autonomous travel). In the first embodiment, an example is described in which the “road classification” of a road is made to correspond to a travel condition of whether or not an autonomous travel of the vehicle 10 is available thereon.

In FIG. 1, each of roads (lanes) Rk, Rk in which the traffic sign K is placed is a road on which priority is given to the vehicle 10 running in an autonomous travel mode. Meanwhile, each of roads (lanes) Rs, Rs on which the traffic sign K is not placed is a road on which the vehicles 10, 30 can run regardless of whether driving in an autonomous travel mode or not. Note that the traffic sign K in FIG. 1 is illustrative only and is not limited thereto.

The traffic sign K representing a road classification is provided such that: a driver of the vehicle 10 traveling on any of the roads Rk, Rk can recognize the road classification thereof; and that a pedestrian or the like (a traffic participant) at and around the intersection C can also recognize the road classification. This makes it possible for the driver to visually confirm the road classification and for the pedestrian or the like to cross the intersection C while also visually confirming the road classification.

The road classification is not limited to that in the above-described example. For example, each of the roads Rk, Rk in which the traffic sign K is installed may be exclusively for the vehicle 10 which performs an autonomous travel thereon. In another example in which a prescribed traffic sign (not illustrated) in a road may prohibit an autonomous travel of the vehicle 10. Such road classifications described above are also those which indicate whether or not an autonomous travel of the vehicle 10 is available on a road of interest.

In addition to those which indicate whether or not an autonomous travel of the vehicle 10 is available on a road of interest, a permission level of the autonomous travel of the vehicle 10 (which may also be referred to as an autonomous travel level) may be used as the road classification. A traffic sign (not illustrated) representing the permission level of an autonomous travel may include, for example, a character and/or a number such as “Level 3”, a sign, a color, a pattern, and a combination thereof.

A plurality of autonomous travel levels are previously set herein, in which, the higher the level, the less the operations required for a driver of the vehicle 10 during traveling. When the vehicle 10 travels on a road at a prescribed permission level of autonomous travel, the vehicle 10 can (or is recommended to) travel at a level same as or lower than the prescribed level.

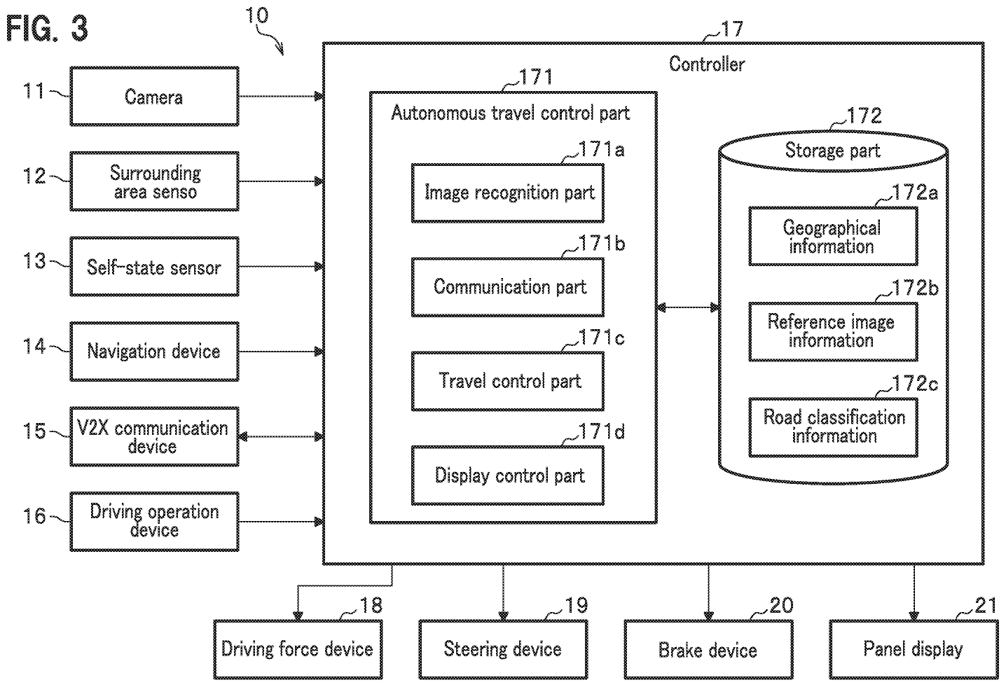

In addition to the traffic sign K including the road marking Ka and the road signage Kb, a shape, a pattern, a color, or the like of a guardrail may be made to correspond to a prescribed road classification. Also, a shape, a pattern, a color, or the like of a road shoulder may be made to correspond to a prescribed road classification. A controller 17 to be described hereinafter (see FIG. 3) may recognize such a road classification, based on a taken image of a road (including the road marking Ka, the road signage Kb, a guardrail, and a road shoulder). Additionally, a road classification may be made to correspond to: whether or not an autonomous travel of the vehicle 10 is available on a road of interest; or a permission level (an autonomous travel level); or both, as a travel condition.

The “autonomous travel” described above is not limited to a so-called fully autonomous travel (a fully automated driving). The “autonomous travel” includes a combination of some operations in an autonomous travel mode and others in a manual mode. For example, the above-described “autonomous travel” includes a case in which a lane change of a vehicle is automated, while the vehicle does not perform an autonomous travel when driving through an intersection (a partially autonomous travel).

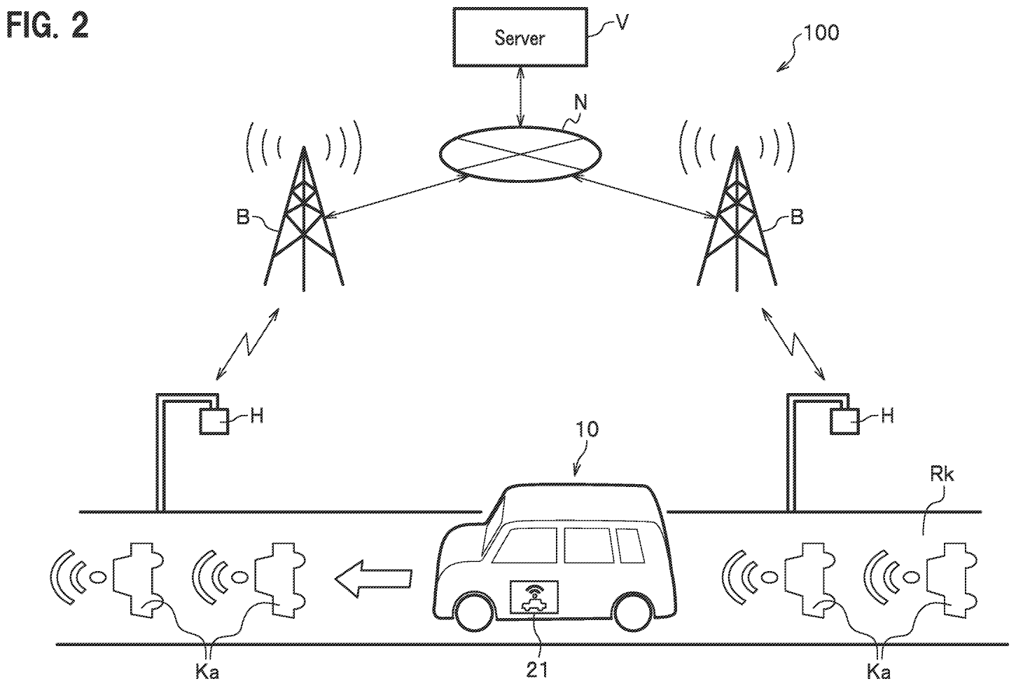

FIG. 2 is a diagram for explaining a driving assistance system 100 including the vehicle 10 equipped with a control device.

Note that FIG. 2 illustrates the road Rk (see also FIG. 1) on which the vehicle 10 travels, without illustrating the other roads.

The driving assistance system 100 is a system for assisting driving of the vehicle 10. The “assistance” of driving used herein includes an assistance performed by the driving assistance system 100 of: a steering operation of the vehicle 10; or an acceleration/deceleration thereof; or both.

In the example illustrated in FIG. 2, the driving assistance system 100 includes a server V, a base station B, the roadside device H, and the vehicle 10. The server V receives information showing a location or a state of the vehicle 10 via the roadside device H or the base station B. The server V generates information used for driving assistance of the vehicle 10; and provides the vehicle 10 with the generated information via the base station B or the roadside device H.

The base station B relays communications between the roadside device H and the server V via a network N. Instead, the server V and the vehicle 10 may directly receive and transmit information via the base station B. The roadside device H performs a road-to-vehicle communication with a nearby vehicle 10. A panel display 21 illustrated in FIG. 2 will be described hereinafter.

FIG. 3 is a functional block diagram of the vehicle 10 including the controller 17. As illustrated in FIG. 3, the vehicle 10 includes a camera 11 (which may also be referred to as an imaging device), a surrounding area sensor 12, a self-state sensor 13, a navigation device 14, a V2X communication device 15, and a driving operation device 16. In addition to the above-described components, the vehicle 10 includes the controller 17 (which may also be referred to as a movable object control device), a driving force device 18, a steering device 19, a brake device 20, and the panel display 21.

The camera 11 is an imaging device which takes an image of at least a road on which the vehicle 10 travels. The camera 11 suitably used herein includes, for example, a CMOS (Complementary Metal Oxide Semiconductor) camera and a CCD (Charge Coupled Device) camera. The camera 11 takes an image of the road marking Ka or the road signage Kb on the road Rk (see FIG. 1).

FIG. 3 illustrates one unit of the camera 11. A plurality of cameras (not illustrated) may be, however, provided. For example, one of a plurality of the cameras 11 may have an optical axis inclined forward and obliquely downward with respect to the vehicle 10 and takes an image of the road marking Ka (see FIG. 1), and another may have an optical axis inclined forward and obliquely upward with respect to the vehicle 10 and takes an image of the road signage Kb (see FIG. 1). One or more other cameras (not illustrated) may be installed in a lateral or a rear part of the vehicle 10.

The surrounding area sensor 12 detects an object present in a surrounding area of the vehicle 10. The surrounding area sensor 12 suitably used herein includes, for example, a radar and a LIDAR (Light Detection and Ranging). The radar (not illustrated) irradiates an object such as a vehicle ahead of the vehicle 10 with a radar wave, to thereby measure a distance from the vehicle 10 to the object or an azimuth orientation thereof. The LIDAR (not illustrated) irradiates an object with light and detects the scattered light and measures a distance from the vehicle 10 to the object based on, for example, a time from the light emission until the detection.

The self-state sensor 13 is a sensor which detects an amount of a prescribed state showing a state of the vehicle 10. The self-state sensor 13 suitably used herein includes, though not illustrated, a speed sensor, an acceleration sensor, a rudder sensor, a pitch sensor, and a yaw rate sensor. A value detected by the self-state sensor 13 is outputted to the controller 17.

The navigation device 14 is a device for finding an appropriate route from a current position of the vehicle 10 to a position specified by a user thereof. The navigation device 14 includes, though not illustrated, a GNSS (Global Navigation Satellite System) receiver and a user interface. The user interface includes, for example, a touch-screen display, a speaker, and a microphone. The navigation device 14: identifies a current position of the vehicle 10, based on a signal received by the GNSS receiver; and determines an appropriate route from the current position to a position specified by a user. A user interface notifies the user of the route determined as described above. Information on the route is outputted to the controller 17.

The V2X communication device 15 performs a vehicle-to-vehicle communication (a V2V communication) between the vehicle 10 itself (which may also be referred to as a subject vehicle) and another vehicle nearby. The V2X communication device 15 also establishes a road-to-vehicle communication (a V2R communication) between the vehicle 10 itself and the roadside device H nearby (see FIG. 2). Upon receipt of a signal in any of the communications, the V2X communication device 15 outputs the received signal to the controller 17.

The driving operation device 16 is a device used for a driving operation by a driver of the vehicle 10. The driving operation device 16 used herein includes, for example, though not illustrated, a steering wheel, a joystick, a button, a dial switch, and a GUI (Graphical User Interface).

The driving operation device 16 of the vehicle 10also includes another device used for switching between start/stop of an autonomous travel thereof. A plurality of levels of the autonomous travel may be previously set. A driver may set an autonomous travel at a desired level by operating the driving operation device 16.

The controller 17 (which may also be referred to as an ECU: Electronic Control Unit) is a device for controlling various components of the vehicle 10, including the driving force device 18, the steering device 19, the brake device 20, and the panel display 21, each illustrated in FIG. 3.

The controller 17 has a hardware configuration including, though not illustrated, a CPU (Central Processing Unit), a ROM (Read Only Memory), a RAM (Random Access Memory), and electronic circuits such as various interfaces. A program stored in the ROM is read and is loaded into the RAM, and the CPU thereby executes various processings.

As illustrated in FIG. 3, the controller 17 includes an autonomous travel control part 171 and a storage part 172.

The storage part 172 stores therein geographical information 172a, reference image information 172b, and road classification information 172c.

The geographical information 172a: is information on a location of a road, a route, and the like, on a map; and is acquired by the navigation device 14.

The reference image information 172b: is information on a prescribed image associated with a road classification regarding autonomous travel; and is previously stored in the storage part 172. More specifically, information on an image corresponding to the road marking Ka (see FIG. 1) or the road signage Kb (see FIG. 1), each of which indicates that a road of interest is a priority road for autonomous travel, is prepared. The prepared information is previously stored in the storage part 172 as the reference image information 172b which is a reference image in pattern matching (which may also be referred to as a prescribed image pattern). The number of the prescribed image patterns corresponding to the reference image information 172b is not limited to one and may be plural.

The road classification information 172c is information showing a classification of a road. As described above, the road classification is a classification by which whether or not an autonomous travel of the vehicle 10 is available on a road of interest, or, if available, at which level the vehicle 10 is permitted to perform the autonomous travel (which may also be referred to as an autonomous travel level). The road classification information 172c includes information showing a correspondence relationship between the reference image information 172b and a prescribed road classification. The road classification information 172c also includes information on a road classification specified based on a result of imaging the road marking Ka (see FIG. 1) or the road signage Kb (see FIG. 1) (that is, a road classification of the road Rk on which the vehicle 10 actually travels).

The autonomous travel control part 171 includes an image recognition part 171a, a communication part 171b, a travel control part 171c (which may also be referred to as a control part), and a display control part 171d (which may also be referred to as a notification part).

The image recognition part 171a recognizes a road classification to which a travel condition is previously made to correspond, based on a result of imaging a road by the camera 11 of the vehicle 10. Such a road classification includes whether or not an autonomous travel of the vehicle 10 is available on the road. For example, the image recognition part 171a performs an image processing such as edge extraction, based on information obtained from an image taken by the camera 11. The image recognition part 171a then recognizes a “road classification” indicated by the road marking Ka (see FIG. 1) or the road signage Kb (see FIG. 1), based on a prescribed template matching. A result recognized by the image recognition part 171a is stored in the storage part 172 as the road classification information 172c.

The communication part 171b is a communication interface which performs input and output of data from and to the V2X communication device 15. The communication part 171b receives information on a road classification or the like from the V2X communication device 15.

The travel control part 171c controls traveling of the vehicle 10, based on, besides the above-described imaging result by the camera 11, a result detected by the surrounding area sensor 12 or the self-state sensor 13, information from the V2X communication device 15, an operation of the driving operation device 16, and the like. In other words, the travel control part 171c provides control over the driving force device 18, the steering device 19, the brake device 20, or the like.

A structure of the driving force device 18 varies depending on a type of the vehicle 10 (an electric vehicle, a hybrid vehicle, a fuel cell vehicle, a gasoline engine vehicle, a diesel engine vehicle, and the like). The structure is well-known, and description thereof is omitted herein. Descriptions of the steering device 19 for steering the vehicle 10 and of the brake device 20 for decelerating the vehicle 10 are also omitted herein.

When the image recognition part 171a recognizes a prescribed shape or image pattern corresponding to a road classification on or around a road on which the vehicle 10 travels, the travel control part 171c performs an autonomous travel of the vehicle 10 in accordance with a travel condition associated with the road classification. Details of such control by the travel control part 171c will be described hereinafter.

The display control part 171d makes the panel display 21 display an appropriate display content, to thereby notify a nearby traffic participant of information on an autonomous travel of the vehicle 10. For example, the display control part 171d makes the panel display 21 display, during an autonomous travel of the vehicle 10, a prescribed symbol or a prescribed character or the like (see also FIG. 2) representing that the vehicle 10 is autonomously driving. The display control part 171d may make the panel display 21 display a prescribed symbol or a prescribed character or the like indicating a current level of an autonomous travel of the vehicle 10 (see also FIG. 2).

The panel display 21 displays a prescribed content representing a travel state of the vehicle 10. The panel display 21: is disposed on, for example, a front door of the vehicle 10; and is recognizable by a pedestrian or the like near the vehicle 10. Note that the panel display 21 may be disposed on the front door of the vehicle 10 as described above or may be disposed on any other part thereof.

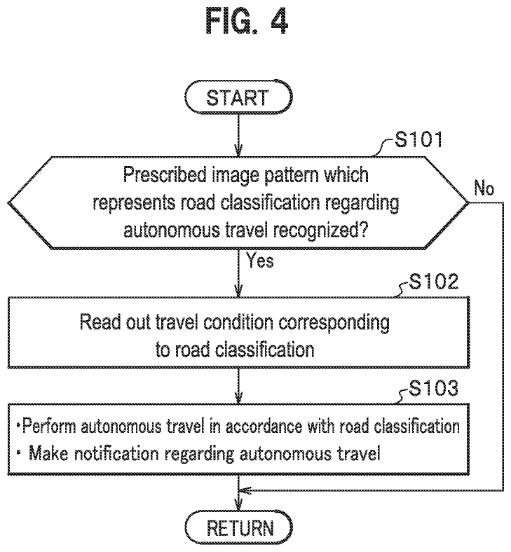

FIG. 4 is a flowchart of a processing performed by the controller 17 (see FIG. 3 where appropriate).

The processing illustrated in FIG. 4 is that concerning a “road classification” of a road on which the vehicle 10 is traveling. Description herein is made assuming that, at a time of “START” in FIG. 4, the vehicle 10 is traveling on a road.

In step S101, the controller 17 determines whether or not the image recognition part 171a has recognized a prescribed image pattern which represents a road classification regarding autonomous travel (an image recognition step). More specifically, the image recognition part 171a of the controller 17 performs a pattern matching between: an image taken by the camera 11; and the reference image information 172b in the storage part 172. If an image pattern corresponding to the image taken by the camera 11 is found in the reference image information 172b, then, in step S101, the controller 17 determines that a prescribed image pattern which represents a road classification regarding an autonomous travel has been recognized (S101: Yes). This makes it possible for the controller 17 to recognize whether or not the road marking Ka (see FIG. 1) or the road signage Kb (see FIG. 1) regarding the autonomous travel is present.

In step S101, if the prescribed image pattern representing the road classification of the autonomous travel is determined to have been recognized (S101: Yes), the controller 17 advances the processing to step S102. In step S101, if the prescribed image pattern representing the road classification of the autonomous travel is not determined to have been recognized (S101: No), the controller 17 repeats step S101 (“RETURN”).

In step S102, the controller 17 reads out a travel condition corresponding to the recognized road classification. For example, the controller 17 reads out, from the storage part 172, prescribed information showing that “an autonomous travel is available”, as a travel condition corresponding to a road classification represented by the road marking Ka (see FIG. 1) or the road signage Kb (see FIG. 1). It is assumed herein that a prescribed table (not illustrated) showing a correspondence relationship between a road classification and a travel condition is previously stored in the storage part 172 (see FIG. 3) of the controller 17. Alternatively, the server V (see FIG. 2) may store therein a prescribed table, and the controller 17 may receive information in the table via the V2X communication device 15 (see FIG. 3).

In step S103, the controller 17: performs an autonomous travel based on the corresponding travel condition (which may also be referred to as a control step); and makes a prescribed notification regarding the autonomous travel. For example, if the controller 17 determines that the vehicle 10 is traveling on a priority road for autonomous travel in accordance with the road marking Ka (see FIG. 1) or the road signage Kb (see FIG. 1) imaged by the camera 11 (S101: Yes), the controller 17 continues the autonomous travel (S103).

In another case in which, for example, if the controller 17 determines that a road for autonomous travel at a prescribed permission level is present ahead in a traveling direction of the vehicle 10, based on the road signage Kb imaged by the camera 11 (S101: Yes), then, when traveling on the road for autonomous travel at the prescribed level, the controller 17 performs the autonomous travel of the vehicle 10 at a level in accordance with the prescribed permission level (S103).

The controller 17 may provide such control that, when a prescribed image pattern relevant to autonomous travel is recognized, the vehicle 10 continues an autonomous travel corresponding to the recognized image pattern until the vehicle 10 travels a prescribed distance from a point of the recognized image pattern. Such a prescribed distance may be previously set, based on, for example, an interval between the road markings Ka or between the road signages Kb.

When a driver is manually driving the vehicle 10, if the controller 17 determines that the vehicle 10 is approaching a road for autonomous travel (or a lane adjacent to that on which the vehicle is traveling is for autonomous travel), based on information obtained from an image taken by the camera 11, the controller 17 may notify the driver that a road for autonomous travel is present ahead, using an in-vehicle display (not illustrated) or a speaker (not illustrated). Upon the notification, if the driver performs a prescribed operation to the driving operation device 16, the controller 17 switches to an autonomous travel in accordance with a prescribed image pattern (a road classification).

In another example, when the vehicle 10 enters a road for autonomous travel, the controller 17 may switch from a driver's manual driving to an autonomous travel, without any operation by the driver.

In step S103, the display control part 171d of the controller 17: makes the panel display 21 display a prescribed content; and makes a notification that the vehicle 10 is running in an autonomous travel mode in accordance with the road classification. This makes it possible to let a traffic participant such as a pedestrian know that the vehicle 10 is travelling in a prescribed autonomous travel mode. Note that, when the display control part 171d recognizes that the vehicle 10 is traveling at a prescribed road classification, based on information obtained from an image taken by the camera 11, the recognition by the display control part 171d is in most cases the same as that visually recognized by a traffic participant nearby. This means that the autonomous travel is performed as expected by the traffic participant, which can give the traffic participant a feeling of safety.

After step S103, the controller 17 returns the processing to “START” (RETURN).

### Advantageous Effects

The controller 17 and other components of the vehicle 10 according to the first embodiment are basically configured as described above. Next are explained advantageous effects of the controller 17.

As illustrated in FIG. 3, the controller 17 (the movable object control device) includes the image recognition part 171a and the travel control part 171c (the control part). The image recognition part 171a recognizes a road classification corresponding to a travel condition of a road on which the vehicle 10 (the movable object) travels, based on information obtained from an image taken by the camera 11 (the imaging device) of the vehicle 10. The travel condition is made to correspond to: whether or not an autonomous travel of the vehicle 10 is available on the road; or a level of the autonomous travel; or both. When the image recognition part 171a recognizes a prescribed shape or a prescribed image pattern corresponding to the road classification on or around the road on which the vehicle 10 travels (S101: Yes in FIG. 4), the travel control part 171c performs an autonomous travel, based on the travel condition corresponding to the road classification (S102, S103).

In the above-described configuration, the travel control part 171c performs an autonomous travel in accordance with a result recognized by the image recognition part 171a. A road classification recognized by the image recognition part 171a is in most cases the same as that obtained by a pedestrian when he/she views the traffic sign K of interest. This makes it possible to actually perform an autonomous travel as expected by a traffic participant near the vehicle 10, which can give the traffic participant a feeling of safety.

### Second Embodiment

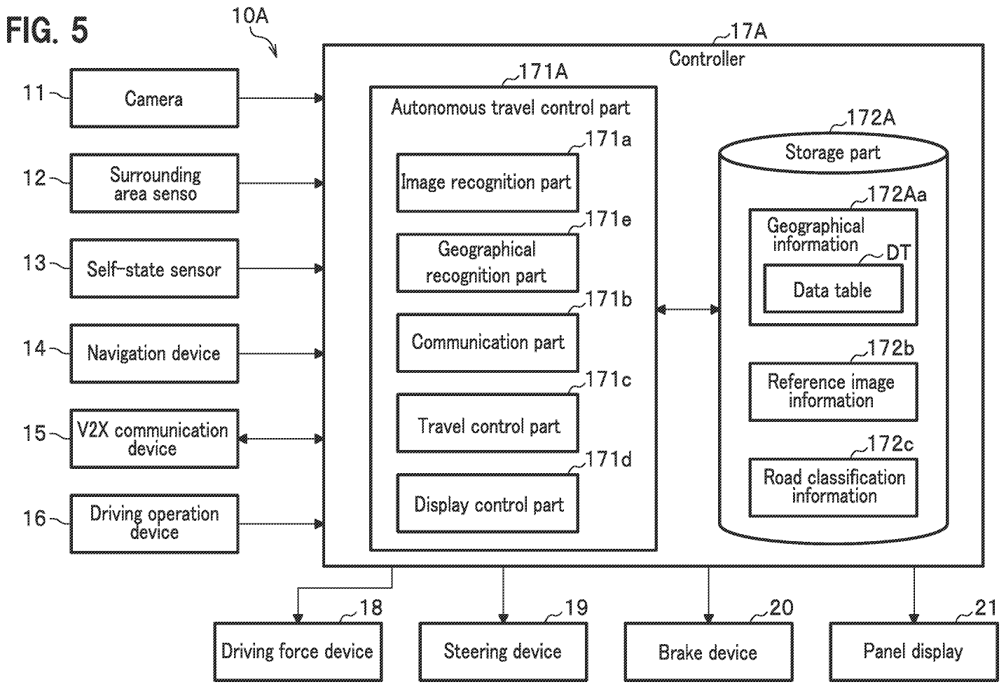

A second embodiment is the same as the first embodiment, except that a controller 17A (see FIG. 5) further includes a geographical recognition part 171e (see FIG. 5). Another difference is that, in the second embodiment, unlike in the first embodiment, if a result recognized by the image recognition part 171a (see FIG. 5) is different from that recognized by the geographical recognition part 171e (see FIG. 5), then that recognized by the image recognition part 171a is used. The configuration of the second embodiment other than the described above is the same as that of the first embodiment. Thus, in the second embodiment, only different constitutional elements will be explained, and explanations of elements same as those in the first embodiment are omitted.

FIG. 5 is a functional block diagram illustrating a vehicle 10A including the controller 17A according to the second embodiment.

As illustrated in FIG. 5, the controller 17A of the vehicle 10A further includes the geographical recognition part 171e, in addition to the constitutional elements described in the first embodiment (see FIG. 3). The geographical recognition part 171e recognizes a travel condition of a road on which the vehicle 10A travels, based on geographical information 172Aa including a correspondence relationship between a location of the road on a map and a travel condition.

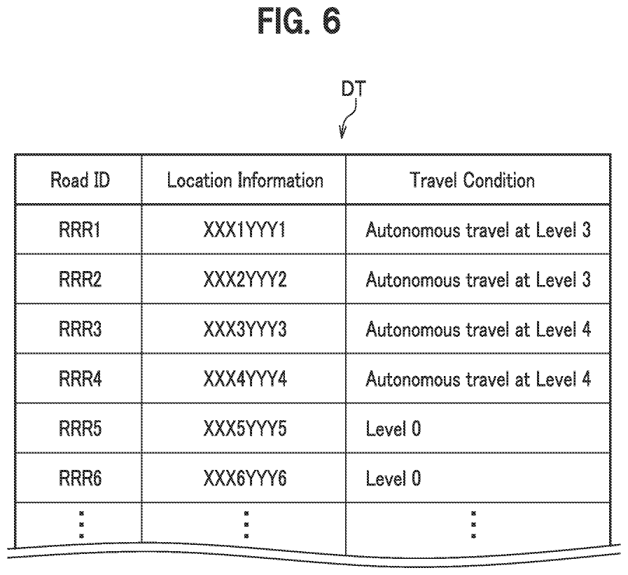

The geographical information 172Aa stored in the storage part 172A of the controller 17A includes a data table DT (see FIG. 6) in which information on a road classification is stored. The data table DT is described below with reference to FIG. 6.

FIG. 6 is a diagram for explaining the data table DT included in the geographical information 172Aa (see FIG. 5 where appropriate).

In an example illustrated in FIG. 6, the data table DT is previously set up in which a road ID of a road, information on a location of the road, and a travel condition thereof, which are associated with each other. Or, the controller 17A may acquire the data table DT from the server V (see FIG. 2) via the base station B (see FIG. 2) or the roadside device H (see FIG. 2). Instead, the storage part 172A (see FIG. 2) of the controller 17A may previously store therein the data table DT.

The road ID in FIG. 6: is information for identifying a road; and is assigned to each of a plurality of roads. The location information shows a location of the road. A road may contain plural pieces of location information such that a route on the road can be identified by not only locations at both ends of the road but also any other location therebetween. The travel condition in FIG. 6: shows a permission level of an autonomous travel of the vehicle 10A; and is previously set in association with a road classification corresponding thereto.

For example, a road with the road ID: RRR1 is previously set such that: the location information thereof is XXX1YYY1; and the travel condition thereof is “Autonomous travel at Level 3”. The autonomous travel at Level 3 herein means that, for example: the driving assistance system 100 (see FIG. 2) or the controller 17A steers, accelerates, and decelerates the vehicle 10A in a prescribed lane on a road; and, in time of emergency, a driver operates the vehicle 10A.

For example, a road with the road ID: RRR3 is previously set such that: the location information thereof is XXX3YYY3; and the travel condition thereof is “Autonomous travel at Level 4”. The autonomous travel at Level 4 herein means that, for example, the driving assistance system 100 (see FIG. 2) or the controller 17A constantly steers, accelerates, and decelerates the vehicle 10A in a prescribed lane on a road, even in time of emergency.

For example, a road with the road ID: RRR5 is previously set such that: the location information thereof is XXX5YYY5; and the travel condition thereof is “Level 0”. The Level 0 herein means, for example, that the driver fully steers, accelerates, and decelerates the vehicle 10A. Note that how the autonomous travel at each of the levels is performed as described above is illustrative only and is not limited thereto.

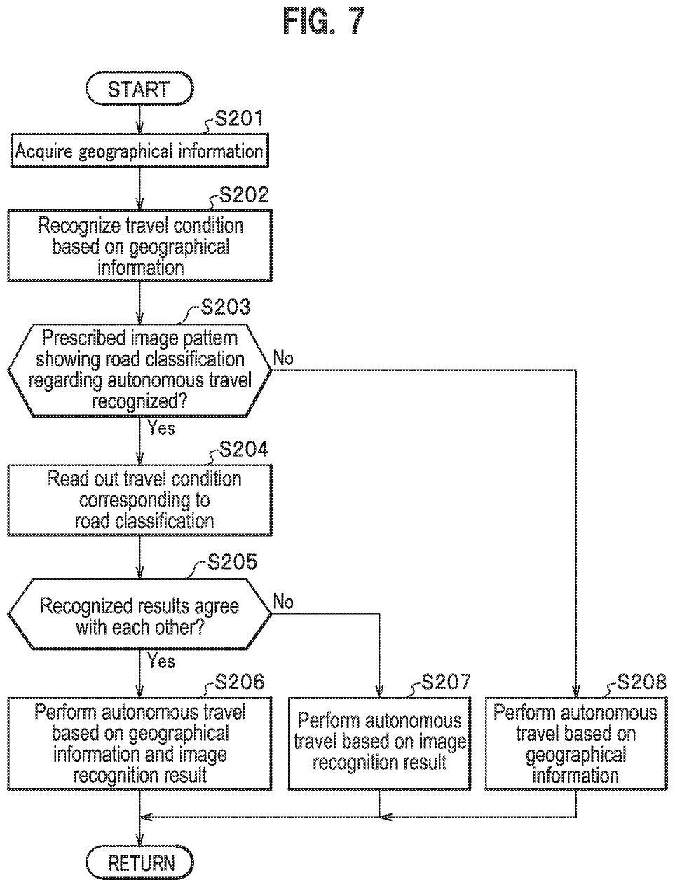

FIG. 7 is a flowchart of a processing performed by the controller 17A (see FIG. 5 where appropriate). Description herein is made assuming that, at a time of “START” in FIG. 7, the vehicle 10A is traveling on a road.

In step S201, the controller 17A acquires the geographical information 172Aa. The geographical information 172Aa contains information on a location of the vehicle 10A, a road ID of each road on a route to a destination, a road classification thereof, a travel condition thereof, or the like.

In step S202, the controller 17A recognizes a travel condition of a road on which the vehicle 10A is traveling, based on the geographical information 172Aa. For example, if the vehicle 10A is recognized to be traveling on a road with the road ID: RRR1 (see FIG. 6), the geographical recognition part 171e of the controller 17A recognizes that a travel condition corresponding to a road classification of the road is an autonomous travel at Level 3.

In step S203, the image recognition part 171a of the controller 17A determines whether or not a prescribed image pattern showing a road classification regarding autonomous travel has been recognized. Note that step S203 is the same as step S101 (see FIG. 4) in the first embodiment.

In step S203, if the prescribed image pattern showing a road classification regarding autonomous travel is determined to have been recognized (S203: Yes), the controller 17A advances the processing to step S204.

In step S204, the controller 17A reads out a travel condition corresponding to the road classification. For example, the controller 17A reads out, from the storage part 172A (see FIG. 5), a data showing that a travel condition corresponding to a prescribed road classification is an autonomous travel at Level 3.

In step S205, the controller 17A determines whether or not the travel condition as a result recognized by the geographical recognition part 171e (S202) agrees with the travel condition as a result recognized by the image recognition part 171a (S203). Actually, in most cases, the recognized results by the geographical recognition part 171e and the image recognition part 171a agree with each other. There is such a case, however: that, though a road classification of a road of interest (or a travel condition corresponding to the road classification) is changed, there is a delay in reflecting the change to the geographical information 172Aa; or that a system failure occurs. In those cases, the results by the geographical recognition part 171e and the image recognition part 171a may not agree with each other.

In step S205, if the travel condition as the result recognized by the geographical recognition part 171e is determined to agree with that by the image recognition part 171a (S205: Yes), the controller 17A advances the processing to step S206.

In step S206, the controller 17A performs the autonomous travel based on the geographical information 172Aa and the image recognition result. In step S205, if the travel condition as the result recognized by the geographical recognition part 171e is not determined to agree with that by the image recognition part 171a (S205: No), the controller 17A advances the processing to step S207.

In step S207, the controller 17A performs an autonomous travel based on the image recognition result. That is, the controller 17A gives priority to the travel condition as the result recognized by the image recognition part 171a, rather than that by the geographical recognition part 171e.

As described above, the result recognized by the image recognition part 171a is in most cases the same as a result visually recognized by a traffic participant nearby. In the second embodiment, the result recognized by the image recognition part 171a is preferentially used, rather than that by the geographical recognition part 171e. This makes it possible to perform an autonomous travel as expected by or close to expectation from the traffic participant, thus allowing the traffic participant near the vehicle 10A to feel a sense of safety.

In step S203, if the prescribed image pattern showing a road classification regarding autonomous travel is not determined to have been recognized (S203: No), the controller 17A advances the processing to step S208. In step S208, the controller 17A performs a prescribed autonomous travel based on the geographical information 172Aa. This makes it possible to perform an appropriate autonomous travel using the geographical information 172Aa, even when the road marking Ka (see FIG. 1) or the road signage Kb (see FIG. 1) is not provided on a road on which the vehicle 10A travels.

After performing an appropriate one of steps S206, S207, and S208, the controller 17A returns the processing to “START” (RETURN).

### Advantageous Effects

The controller 17 and other components of the vehicle 10 according to the second embodiment are basically configured as described above. Next are explained advantageous effects of the controller 17.

As illustrated in FIG. 5 to FIG. 7, the controller 17A (a movable object control device) further includes the geographical recognition part 171e that is configured to recognize a travel condition of a road on which the vehicle 10A (the movable object) travels, based on the geographical information 172Aa containing a correspondence relationship between a position of the vehicle 10A on a map and a travel condition at the position. In the above-described configuration, if a travel condition corresponding to a road classification corresponding to a shape or an image pattern on a road recognized by the image recognition part 171a is different from the travel condition recognized by the geographical recognition part 171e (S205: No in FIG. 7), then the travel control part 171c (the control part) performs an autonomous travel of the vehicle 10A (the movable object), based on the travel condition corresponding to a road classification corresponding to a shape or an image pattern on a road recognized by the image recognition part 171a (S207).

In the above-described configuration, even when the results recognized by the geographical recognition part 171e and by the image recognition part 171a do not agree with each other, the controller 17A can perform an autonomous travel as expected by or close to expectation from a pedestrian or the like who has actually viewed the road marking Ka (see FIG. 1) or the road signage Kb (see FIG. 1) of interest.

### Third Embodiment

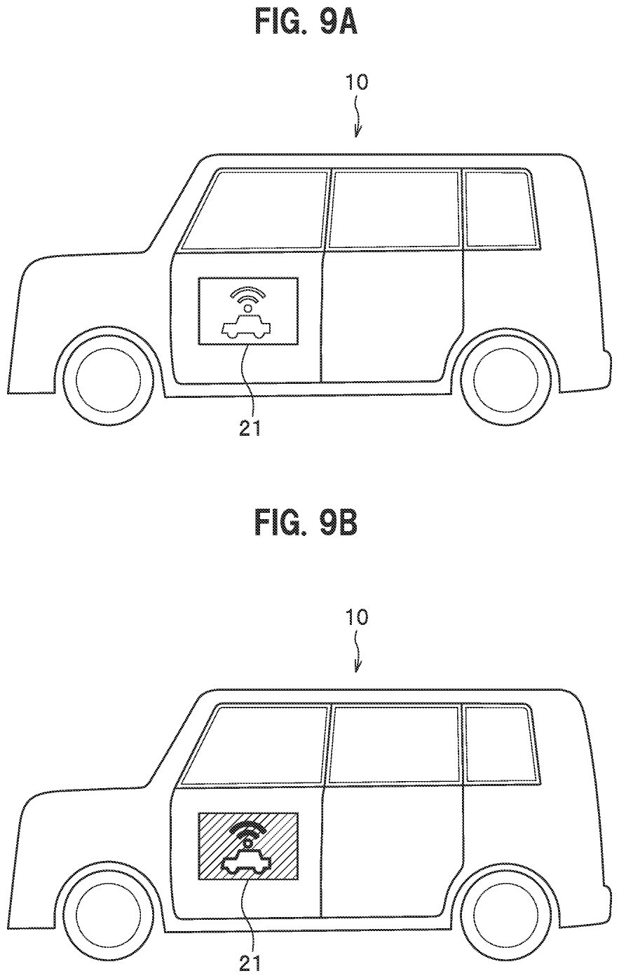

A third embodiment of the present invention is the same as the first embodiment thereof, except that in the third embodiment, a degree of attracting attention to a traffic participant is changed by changing displays in the panel display 21 (see FIG. 9A and FIG. 9B), based on a relationship between a road classification recognized and a travel state of the vehicle 10. A configuration of the third embodiment is the same as that of the first embodiment other than the described above (such as the configuration of the controller 17: see FIG. 3). Thus, in the third embodiment, only elements different from those in the first embodiment will be explained, and explanations of elements same as those in the first embodiment are omitted herein.

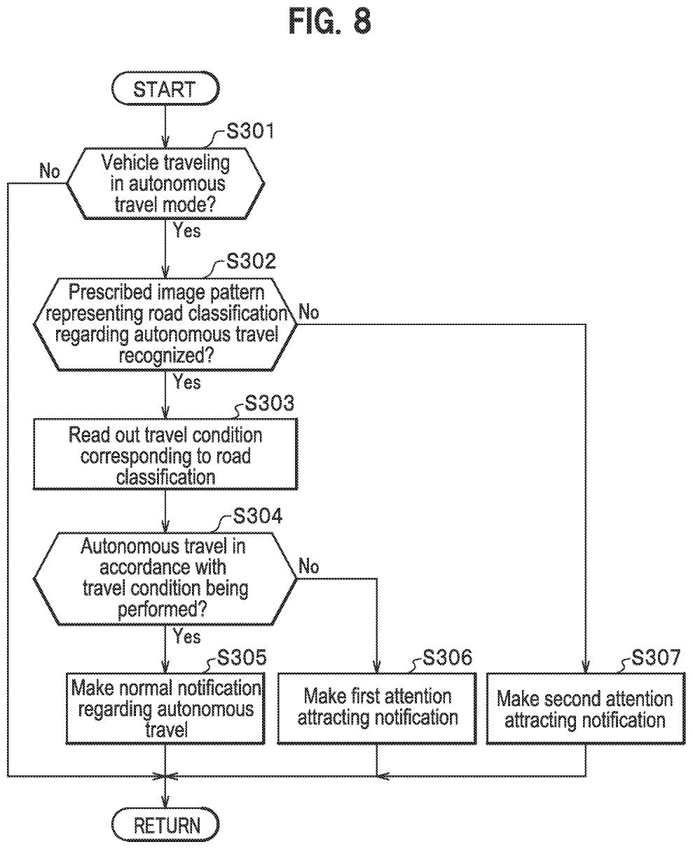

FIG. 8 is a flowchart of a processing performed by the controller 17 according to the third embodiment (see FIG. 3 where appropriate). Description herein is made assuming that, at a time of “START” in FIG. 8, the vehicle 10A is traveling on a road.

In step S301, the controller 17 determines whether or not the vehicle 10 (which may also be referred to as a subject vehicle) is traveling in an autonomous travel mode. If the vehicle 10 is not determined to be traveling in the autonomous travel mode (S301: No), the controller 17 returns the processing to “START” (RETURN). If the vehicle 10 is determined to be traveling in the autonomous travel mode (S301: Yes), the controller 17 advances the processing to step S302.

In step S302, the controller 17 determines whether or not the image recognition part 171a has recognized a prescribed image pattern representing a road classification regarding autonomous travel. Note that step S302 is the same as step S101 (see FIG. 4) described in the first embodiment. In step S302, if the prescribed image pattern is determined to have been recognized (S302: Yes), the controller 17 advances the processing to step S303.

In step S303, the controller 17 reads out a travel condition corresponding to the road classification. For example, the controller 17 reads out, from the storage part 172 (see FIG. 3), a data showing that a travel condition corresponding to the road classification is that of an autonomous travel at Level 3.

In step S304, the controller 17 determines whether or not an autonomous travel is being performed in accordance with the read travel condition. For example, when the image recognition part 171a recognizes that a road on which the vehicle 10 is traveling is that for an autonomous travel at Level 3, based on information obtained from an image taken by the camera 11, then the controller 17 determines whether or not the vehicle 10 (a subject vehicle) is currently traveling in an autonomous travel mode at Level 3.

In step S304, if the autonomous travel is determined to be being performed in accordance with the travel condition (S304: Yes), the controller 17 advances the processing to step S305. In step S305, the controller 17 makes a normal notification of the autonomous travel.

FIG. 9A is a diagram for explaining an example of a display in the panel display 21, in which an autonomous travel of the vehicle 10 is performed in accordance with a road classification of interest.

If an autonomous travel in accordance with a prescribed road classification represented by the road marking Ka (see FIG. 1) or the road signage Kb (see FIG. 1) is determined to be being performed (S304: Yes in FIG. 8), then, for example, as illustrated in FIG. 9A, the display control part 171d (see FIG. 2) of the controller 17 lights a prescribed sign in a prescribed color showing that the vehicle 10 is traveling in an autonomous travel mode. This makes it possible for a traffic participant such as a pedestrian nearby to recognize that the vehicle 10 is traveling in the autonomous travel mode in accordance with the road classification. Besides the sign illustrated in FIG. 9A, the panel display 21 may display a combination of a sign(s) and a character(s), a character(s) alone, or the like.

Description below is made by referring back to FIG. 8.

In step S304, if an autonomous travel in accordance with the travel condition is not determined to be being performed (S304: No), the controller 17 advances the processing to step S306. In step S306, the controller 17 makes a first attention attracting notification. More specifically, the controller 17 makes the first attention attracting notification showing that the vehicle 10 is traveling in an autonomous travel mode at a level which is different from that actually indicated by a road classification of interest (S306).

FIG. 9B is a diagram for explaining an example of a display in the panel display 21 in which an autonomous travel is performed at a level different from that actually indicated by a road classification of interest.

Let us assume a case in which, for example, when the vehicle 10 is traveling on a road for the autonomous travel at Level 3, the vehicle 10 is actually traveling in an autonomous travel mode at Level 4. In this case, as illustrated in FIG. 9B, the display control part 171d of the controller 17 makes the panel display 21 display a prescribed sign in a color different from that at normal times (see FIG. 9A). This makes it possible for a traffic participant to recognize that the vehicle 10 is traveling in an autonomous travel mode at a level different from that actual indicated by a road classification of interest.

As described above, the panel display 21 is controlled such that a degree of attracting attention (which may also be referred to as a notification level) be higher when the vehicle 10 performs an autonomous travel at a level not in accordance with a road classification of interest (see FIG. 9B), compared with that when the vehicle 10 performs an autonomous travel at a level in accordance with the road classification (see FIG. 9A). For example, the controller 17 may make the panel display 21 flash or turn to an eye-catching color. Or, the controller 17 may output sound, in addition to a display in the panel display 21.

Assume another case in which the vehicle 10 performs an autonomous travel at a level higher than that in accordance with a road classification recognized by the image recognition part 171a (that is, at a level at which a degree of driver intervention is lower). Then, the controller 17 may make the panel display 21 display a prescribed notification at a level higher in attracting attention to a traffic participant (a notification level), compared with when the vehicle 10 performs an autonomous travel at a level in accordance with the road classification. In this case, the controller 17 may make the panel display 21 display a level of an automated driving actually being performed by the vehicle 10.

Similarly, let us assume a still another case in which the vehicle 10 performs an autonomous travel at a level lower than that corresponding to a road classification recognized by the image recognition part 171a (that is, at a level at which a degree of driver intervention is higher). Then, the controller 17 may make the panel display 21 display a prescribed notification at a level higher in attracting attention to a traffic participant (a notification level), compared with that when the vehicle 10 performs an autonomous travel at a level in accordance with the road classification. In this case, the controller 17 may make the panel display 21 display a level of an automated driving actually being performed by the vehicle 10. This is because, in some cases, an autonomous travel (an automated driving) of the vehicle 10 can properly deal with a wider range of situations than a driver thereof can.

The controller 17 may provide control over the panel display 21 such that the following two cases be distinguished from each other. One is a case in which an autonomous travel is performed at a level higher than that corresponding to a road classification recognized by the image recognition part 171a; and the other, at a level lower. The two cases may be differently recognized by, for example: displaying a sign, a character, a color, or the like, in the panel display 21; lighting or flashing the panel display 21; and outputting or not outputting sound.

In step S302 in FIG. 8, if the prescribed image pattern is not determined to have been recognized by the image recognition part 171a (S302: No), the controller 17 advances the processing to step S307. In step S307, the controller 17 makes a second attention attracting notification. More specifically, the controller 17 makes the second attention attracting notification showing that, though the road of interest is not for autonomous travel, an autonomous travel is actually being performed (S307). This makes it possible for a traffic participant to recognize that the vehicle 10 is traveling in an autonomous travel mode, not in accordance with a road classification on the road.

Though not illustrated, the panel display 21 may display the second attention attracting notification such that a degree of attracting attention (a notification level) to a traffic participant be higher than that when an autonomous travel is performed in accordance with a road classification of interest (see FIG. 9A). For example, the panel display 21 may be made to flash or may be turned in an eye-catching color. Or, in addition to a display in the panel display 21, voice or sound may be outputted.

The degree of attracting attention (the notification level) of the second attention attracting notification (S307) may be made higher than that of the first attention attracting notification (S306). This is because, when the second attention attracting notification is made, an autonomous travel is being performed, despite of absence of the traffic sign K for permitting an autonomous travel (see FIG. 1).

After performing an appropriate one of steps S305, S306, and S307, the controller 17 returns the processing to “START” (RETURN).

### Advantageous Effects

The controller 17 and other components of the vehicle 10 according to the third embodiment are basically configured as described above. Next are explained advantageous effects of the controller 17.

As illustrated in FIG. 8, FIG. 9A, and FIG. 9B, the controller 17 (the movable object control device) includes the display control part 171d (the notification part) that is configured to make a prescribed notification concerning an autonomous travel of the vehicle 10 (the movable object) to a traffic participant. In the above-described configuration, when an autonomous travel of the vehicle 10 (the movable object) is being performed in a condition in which a prescribed shape or a prescribed image pattern is not determined to have been recognized by the image recognition part 171a (S302: No), the travel control part 171c (the control part) raises a notification level at which the display control part 171d (the notification part) makes a notification to a traffic participant, compared with that when an autonomous travel of the vehicle 10 is being performed in a condition in which a prescribed shape or a prescribed image pattern is determined to have been recognized by the image recognition part 171a (S307).

In the above-described configuration, the controller 17 can notify a pedestrian or the like that the vehicle 10 is inappropriately running in an autonomous travel mode on a road of interest, though the road does not provide the traffic sign K for permitting an autonomous travel, which can bring attention of the pedestrian or the like to the vehicle 10.

The controller 17 (the movable object control device) may perform a processing as follows. Assume a case in which the vehicle 10 is running in an autonomous travel mode, based on a travel condition corresponding to a prescribed shape or a prescribed image pattern, though, actually, the image recognition part 171a has not recognized the prescribed shape or the prescribed image pattern. In this case, the travel control part 171c (the control part) of the controller 17 raises a notification level at which the display control part 171d (the notification part) makes a notification to a traffic participant, compared with that when the vehicle 10 is running in an autonomous travel mode, based on a travel condition corresponding to a prescribed shape or a prescribed image pattern which has been recognized by the image recognition part 171a.

In the above-described configuration, the controller 17 can notify a pedestrian or the like that the vehicle 10 is inappropriately running in an autonomous travel mode on a road of interest, despite absence of the traffic sign K for permitting an autonomous travel on the road, which can bring attention of the pedestrian or the like to the vehicle 10.

The controller 17 (the movable object control device) includes the display control part 171d (the notification part) that is configured to notify a traffic participant of information on an autonomous travel of the vehicle 10 (the movable object). In the above-described configuration, the travel control part 171c performs a processing as follows. Assume a case in which: an autonomous travel of the vehicle 10 is performed after the image recognition part 171a has recognized a prescribed shape or a prescribed image pattern; and then, an actual autonomous travel of the vehicle 10 is being performed under a travel condition different from that corresponding to the prescribed shape or the prescribed image pattern having been recognized by the image recognition part 171a (S304: No). In this case, the travel control part 171c (the control part) raises a notification level at which the display control part 171d (the notification part) makes a notification to a traffic participant, compared with that when an autonomous travel of the vehicle 10 is performed in accordance with the corresponding travel condition (S306).

In the above-described configuration, the controller 17 can notify a pedestrian or the like that the vehicle 10 is inappropriately running in an autonomous travel mode at a level different from a permission level of a road classification of interest, which can bring attention of the pedestrian or the like to the vehicle 10.

### <<Variations>>

The controller 17 and other constituent elements have been explained above in the embodiments of the present invention. The present invention is not, however, limited to those embodiments, and various changes can be made.

The second embodiment describes that, for example, if a travel condition as a result recognized by the the geographical information 172Aa (see FIG. 5) is not determined to agree with a travel condition as a result of an image recognition (S205: No in FIG. 7), the controller 17A gives priority to the result of the image recognition (S207). The present invention is not, however, limited to this. For example, in the configuration in which the controller 17A (the movable object control device) includes the communication part 171b configured to receive information on a travel condition from the server V (a prescribed externally-disposed device), the controller 17A may perform a processing as follows. Assume a case in which a travel condition corresponding to a road classification associated with a shape of a road or an image pattern recognized by the image recognition part 171a is different from a travel condition received by the communication part 171b. Then, the travel control part 171c of the controller 17A performs an autonomous travel of the vehicle 10 (the movable object), based on the travel condition corresponding to the road classification associated with the shape of the road or the image pattern recognized by the image recognition part 171a.

In the above-described configuration, even when the result recognized by the image recognition part 171a does not agree with that recognized by the communication part 171b, an autonomous travel can be performed as expected by or close to expectation from a pedestrian or the like who has actually viewed the road marking Ka or the road signage Kb of interest.

In each of the embodiments, the vehicle 10 or 10A as the “movable object” is applicable to, besides a four-wheel vehicle, for example, a two-wheel vehicle, a three-wheel vehicle, and any other vehicles. A program or any other information for causing a computer to execute the control method (which may also be referred to as a movable object control method) as described in each of the embodiments can be stored in a memory, a hard disk, a recording medium such as an IC (Integrated Circuit) card.

In each of the embodiments, a pedestrian or the like is notified of a prescribed notification by means of a display in the panel display 21. The present invention is not, however, limited to this. Another example is applicable in which: the vehicle 10 is equipped with a lamp (not illustrated); and the controller 17 makes a prescribed notification of an autonomous travel by putting the lamp on or flashing the lamp. Instead of a display in the panel display 21, a pedestrian or the like may be notified of an autonomous travel by means of a sound outputted from a speaker (not illustrated). Also, a display in the panel display 21 combined with a sound from a speaker can be used. In order to draw attention of a pedestrian or the like nearby, the vehicle 10 may output a prescribed display or sound to a mobile terminal (not illustrated) of the pedestrian or the like via wireless communication.

The embodiments of the present invention can be appropriately combined with each other. For example, the second embodiment is combined with the third embodiment. In this case, if the geographical information 172Aa does not agree with an image recognition result, the controller 17 provides control such that priority be given to the image recognition result (the second embodiment). Then, if a permission level of a road classification based on the image recognition is different from a level of an actual autonomous travel of the vehicle 10, the controller 17 makes a first attention attracting notification (see the third embodiment).

In each of the embodiments, both the road marking Ka (see FIG. 1) and the road signage Kb (see FIG. 1) are placed on the road Rk. The present invention is not, however, limited to this. Each of the embodiments can be carried out even when only one of the road marking Ka and the road signage Kb is placed on a road of interest, without the other placed thereon. Each of the embodiments can also be carried out, when, for example, a road of interest is under construction and a temporary road signage or the like is placed thereon.

### DESCRIPTION OF REFERENCE NUMERALS

100 driving assistance system
10, 10A vehicle (movable object)
11 camera (imaging device)
12 surrounding area sensor
13 self-state sensor
14 navigation device
15 V2X communication device
16 driving operation device
17, 17A controller (movable object control device)
171 autonomous travel control part
172, 172A storage part
172a geographical information
172b reference image information
172c road classification information
171a image recognition part
171b communication part
171c travel control part (control part)
171d display control part (notification part)
171e geographical recognition part
172Aa geographical information
18 driving force device
19 steering device
20 brake device
21 panel display
100 driving assistance system
Ka road marking
Kb road signage
K traffic sign
Rk, Rs road
V server (prescribed device)

1. A movable object control device, comprising:
an image recognition part configured to recognize a road classification made to correspond to a travel condition which includes whether or not an autonomous travel of the movable object is available on a road on which the movable object travels, or an autonomous travel level thereon, or both, based on information obtained from an image taken by an imaging device of the movable object; and
a control part configured to, when the image recognition part has recognized a prescribed shape or a prescribed image pattern made to correspond to the road classification, on or around the road on which the movable object travels, perform an autonomous travel of the movable object, based on the travel condition corresponding to the road classification.

2. The movable object control device according to claim 1, further comprising a geographical recognition part configured to recognize a travel condition of a road on which the movable object travels, based on geographical information including a correspondence relationship between a location of the road on a map and the travel condition thereof,
wherein, when a travel condition corresponding to the road classification corresponding to a shape or an image pattern on the road recognized by the image recognition part is different from a travel condition recognized by the geographical recognition part, then the control part is configured to perform an autonomous travel of the movable object, based on the travel condition corresponding to the road classification corresponding to the shape or the image pattern on the road recognized by the image recognition part.

3. The movable object control device according to claim 1, further comprising a communication part configured to receive information on a travel condition of a road on which the movable object travels,
wherein, when a travel condition corresponding to the road classification corresponding to a shape or an image pattern on the road recognized by the image recognition part is different from a travel condition received by the communication part, then the control part is configured to perform an autonomous travel of the movable object, based on the travel condition corresponding to the road classification corresponding to the shape or the image pattern on the road recognized by the image recognition part.

4. The movable object control device according to claim 1, further comprising a notification part configured to make a prescribed notification regarding the autonomous travel of the movable object,
wherein, when an autonomous travel of the movable object is being performed in a condition in which the image recognition part has not recognized a prescribed shape or a prescribed image pattern, then the control part is configured to raise a notification level at which the notification part makes a notification to a traffic participant, compared with that when an autonomous travel of the movable object is being performed in a condition in which the image recognition part has recognized a prescribed shape or a prescribed image pattern.

5. The movable object control device according to claim 2, further comprising a notification part configured to make a prescribed notification regarding the autonomous travel of the movable object,
wherein, when an autonomous travel of the movable object is being performed in a condition in which the image recognition part has not recognized a prescribed shape or a prescribed image pattern, then the control part is configured to raise a notification level at which the notification part makes a notification to a traffic participant, compared with that when an autonomous travel of the movable object is being performed in a condition in which the image recognition part has recognized a prescribed shape or a prescribed image pattern.

6. The movable object control device according to claim 3, further comprising a notification part configured to make a prescribed notification regarding the autonomous travel of the movable object,
wherein, when an autonomous travel of the movable object is being performed in a condition in which the image recognition part has not recognized a prescribed shape or a prescribed image pattern, then the control part is configured to raise a notification level at which the notification part makes a notification to a traffic participant, compared with that when an autonomous travel of the movable object is being performed in a condition in which the image recognition part has recognized a prescribed shape or a prescribed image pattern.

7. The movable object control device according to claim 4,
wherein, when an autonomous travel of the movable object is being performed, based on a travel condition corresponding to a prescribed shape or a prescribed image pattern, even though, actually, the image recognition part has not recognized the prescribed shape or the prescribed image pattern, then the control part is configured to raise a notification level at which the notification part makes a notification to a traffic participant, compared with that when an autonomous travel of the movable object is being performed, based on the travel condition corresponding to the prescribed shape or the prescribed image pattern, under a condition under which the image recognition part has actually recognized the prescribed shape or the prescribed image pattern.

8. The movable object control device according to claim 5,
wherein, when an autonomous travel of the movable object is being performed, based on a travel condition corresponding to a prescribed shape or a prescribed image pattern, even though, actually, the image recognition part has not recognized the prescribed shape or the prescribed image pattern, then the control part is configured to raise a notification level at which the notification part makes a notification to a traffic participant, compared with that when an autonomous travel of the movable object is being performed, based on the travel condition corresponding to the prescribed shape or the prescribed image pattern, under a condition under which the image recognition part has actually recognized the prescribed shape or the prescribed image pattern.

9. The movable object control device according to claim 6,
wherein, when an autonomous travel of the movable object is being performed, based on a travel condition corresponding to a prescribed shape or a prescribed image pattern, even though, actually, the image recognition part has not recognized the prescribed shape or the prescribed image pattern, then the control part is configured to raise a notification level at which the notification part makes a notification to a traffic participant, compared with that when an autonomous travel of the movable object is being performed, based on the travel condition corresponding to the prescribed shape or the prescribed image pattern, under a condition under which the image recognition part has actually recognized the prescribed shape or the prescribed image pattern.

10. The movable object control device according to claim 1, further comprising a notification part that is configured to make a prescribed notification regarding an autonomous travel of the movable object to a traffic participant,
wherein, when an autonomous travel of the movable object is being performed in a condition in which the image recognition part has recognized a prescribed shape or a prescribed image pattern, if a travel condition of an autonomous travel actually performed by the movable object is different from a travel condition corresponding to the prescribed shape or the prescribed image pattern recognized by the image recognition part, then the control part is configured to raise a notification level at which the notification part makes a notification to a traffic participant, compared with that when an autonomous travel of the movable object is being performed in accordance with the travel condition.

11. The movable object control device according to claim 2, further comprising a notification part that is configured to make a prescribed notification regarding an autonomous travel of the movable object to a traffic participant,
wherein, when an autonomous travel of the movable object is being performed in a condition in which the image recognition part has recognized a prescribed shape or a prescribed image pattern, if a travel condition of an autonomous travel actually performed by the movable object is different from a travel condition corresponding to the prescribed shape or the prescribed image pattern recognized by the image recognition part, then the control part is configured to raise a notification level at which the notification part makes a notification to a traffic participant, compared with that when an autonomous travel of the movable object is being performed in accordance with the travel condition.

12. The movable object control device according to claim 3, further comprising a notification part that is configured to make a prescribed notification regarding an autonomous travel of the movable object to a traffic participant,
wherein, when an autonomous travel of the movable object is being performed in a condition in which the image recognition part has recognized a prescribed shape or a prescribed image pattern, if a travel condition of an autonomous travel actually performed by the movable object is different from a travel condition corresponding to the prescribed shape or the prescribed image pattern recognized by the image recognition part, then the control part is configured to raise a notification level at which the notification part makes a notification to a traffic participant, compared with that when an autonomous travel of the movable object is being performed in accordance with the travel condition.

13. A movable object control method, comprising:
an image recognition step of recognizing a road classification made to correspond to a travel condition which includes whether or not an autonomous travel of the movable object is available on a road on which the movable object travels, or an autonomous travel level thereon, or both, based on information obtained from an image taken by an imaging device of the movable object; and
a control step of, when a prescribed shape or a prescribed image pattern made to correspond to the road classification is recognized on or around the road on which the movable object travels, performing an autonomous travel of the movable object, based on the travel condition corresponding to the road classification.

14. A storage medium storing program embodied on a non-transitory computer-readable medium, the program for causing a computer to execute the movable object control method according to claim 13.
